(19) United States
(12) Patent Application Publication
(10) Pub. No.: US 2014/0069391 A1
(43) Pub. Date: Mar. 13, 2014

(54) FUEL INJECTION CONTROLLER

(71) Applicant: DENSO CORPORATION, Kariya-city (JP)

(72) Inventors: Toshio NISHIMURA, Anjo-city (JP); Takayoshi HONDA, Nagoya-city (JP)

(73) Assignee: DENSO CORPORATION, kariya-city (JP)

(21) Appl. No.: 14/017,579

(22) Filed: Sep. 4, 2013

(30) Foreign Application Priority Data
Sep. 13, 2012 (JP) 2012-202006

(51) Int. Cl. F02D 41/30

(52) U.S. Cl. CPC F02D 41/30
USPC 123/478

(57) ABSTRACT

A fuel injection controller has terminals which can be connected to the coil of the fuel injector. A first valve-open control portion supplies the valve-opening voltage to the terminals for opening the fuel injector. The first valve-open control portion stops supplying the electric supply to the coil before the fuel injector is positioned at a full-open position. Before the fuel injector is fully dosed, a small injection quantity can be obtained. A demagnetization portion forms a demagnetization circuit for demagnetizing the magnetism remaining in the coil. A normal-injection portion controls the fuel injector at full-open position.

### CROSS-REFERENCE TO RELATED APPLICATION

This application is based on Japanese Patent Application No. 2012-202006 filed on Sep. 13, 2012, the disclosure of which is incorporated herein by reference.

### TECHNICAL FIELD

The present disclosure relates to a fuel injection controller which controls a fuel injector.

### BACKGROUND

JP-2010-532448A, JP-2010-73705A, JP-10-18888A, and JP-10-47140A disclose a fuel injection controller which controls a fuel injector. Especially, JP-10-47140A discloses a fuel injection controller having a high speed response. A conventional fuel injection controller supplies comparatively large voltage for opening the fuel injector. While the fuel injector is fully opened, the fuel injection controller supplies comparatively small electric current for maintaining the fuel injector fully opened. Further, the conventional fuel injection controller supplies a reverse direction voltage to perform a demagnetization of the exciting circuit, when the fuel injector will be fully closed.

A fuel injection quantity of a fuel injector is adjusted by controlling a valve opening period of the fuel injector. In order to obtain small injection quantity, it is necessary to shorten the valve opening period of the fuel injector. However, in the small injection quantity, an error of injection quantity is significant. Thus, an accurate injection quantity control is difficult. For example, the error of fuel injection quantity is generated by various factors, such as an error of the mechanical shape of a fuel injector, an error of electric current, and an error of voltage.

In order to obtain small injection quantity, further improvements are necessary in a fuel injection controller.

### SUMMARY

It is an object of the present disclosure to provide a fuel injection controller which can obtain small injection quantity correctly.

A fuel injection controller has terminals connectable to a coil of a fuel injector. Further, the controller has a valve-open control portion which supplies a valve-opening voltage to the terminals for opening the fuel injector and terminates the supply of the valve-opening voltage before the fuel injector is fully opened. Further, the controller has a demagnetization portion which forms a demagnetization circuit for demagnetizing a magnetism remaining in the coil after supplying the valve-opening voltage. According to the above configuration, the small injection quantity can be correctly injected.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram showing an internal combustion engine system according to a first embodiment;

FIG. 2 is a circuit diagram of a driving circuit according to the first embodiment;

FIG. 3 is a flowchart illustrating a control processing according to the first embodiment; and

FIG. 4 is a time chart showing an operation according to the first embodiment.

FIG. 5 is a circuit diagram of a driving circuit according to a second embodiment;

FIG. 6 is a flowchart illustrating a control processing according to the second embodiment;

FIG. 7 is a time chart showing an operation according to the second embodiment;

FIG. 8 is a circuit diagram of a driving circuit according to a third embodiment;

FIG. 9 is a flowchart illustrating a control processing according to the third embodiment; and

FIG. 10 is a time chart showing an operation according to the third embodiment;

### DETAILED DESCRIPTION

Referring to drawings, embodiments of the present disclosure will be described hereinafter. In these embodiments, the same parts and components as those in each embodiment are indicated with the same reference numerals and the same descriptions will not be reiterated.

### First Embodiment

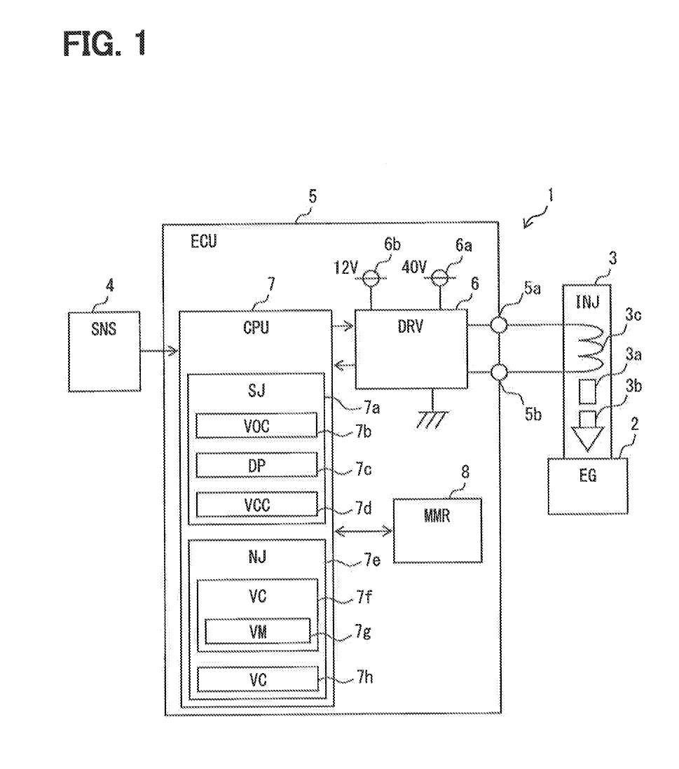

FIG. 1 shows an internal combustion engine system 1 according to a first embodiment. The internal combustion engine system 1 is provided with an internal combustion engine 2 for a vehicle. The internal combustion engine system 1 is provided with a fuel supply system for supplying a fuel to the internal combustion engine 2. The fuel supply system is comprised of a fuel injector (INJ) 3, multiple sensors (SNS) 4, and a fuel injection controller (ECU) 5.

The fuel injector 3 is a normally-closed type solenoid valve. The fuel injector 3 receives pressurized fuel from a fuel pump (not shown). When the fuel injector 3 is opened, the pressurized fuel is injected into the internal combustion engine 2. The fuel injector 3 is arranged in an intake passage of the internal combustion engine 2. In this case, the fuel injector 3 injects a fuel towards an intake air to form air-fuel mixture. Alternatively, the fuel injector 3 is arranged in a cylinder head of the internal combustion engine 2. In this case, the fuel injector 3 injects a fuel towards a combustion chamber.

The fuel injector 3 is comprised of a stator 3a including a fixed core, a needle 3b including a movable valve and a movable core, and a coil 3c for magnetizing the stator 3a. The coil 3c is a magnetic coil. When the coil 3c is energized, the needle 3b is magnetically attracted toward the stator 3a. The needle 3b is biased in a valve-closing direction by a spring (not shown).

When the coil 3c is not energized, the needle 3b is biased in a valve-closing direction. Therefore, when the coil 3c is not energized, the fuel injector 3 injects no fuel. When the coil 3c is energized, the needle 3b is magnetically attracted toward the stator 3a. The fuel injector 3 is opened to inject the fuel. There is a specified time delay from when the coil 3c is energized until when the fuel injector 3 is opened. When the coil 3c is deenergized, the fuel injector 3 is closed to stop the fuel injection. There is a specified time delay from when the coil 3c is deenergized until when the fuel injector 3 is closed.

The sensors 4 include an accelerator sensor, an engine speed sensor, and an intake-air sensor detecting an intake air quantity.

The fuel injection controller 5 is an electronic control unit (ECU). The ECU 5 has terminals 5a and 5b which can be connected to the coil 3c of the fuel injector 3. The ECU5 has a drive circuit (DRV) 6 for supplying electricity to the coil 3c. The drive circuit 6 has a high voltage supply 6a for driving the fuel injector 3 at high speed, and a low voltage supply 6b for driving the fuel injector 3 at low speed.

The high voltage supply 6a is connected to a booster circuit which boosts a battery voltage. The voltage “VF1” of the high voltage supply 6a is 40V. The low voltage supply 6b is connected to a battery of a vehicle. The Voltage VF2 of the low voltage supply 6b is lower than the voltage VF1 of the high voltage supply 6a. The voltage “VF2” of the low voltage supply 6b is 12V.

The ECU 5 has a processing unit (CPU) 7 and a memory (MMR) 8 in which programs are stored. The ECU 5 is a microcomputer having a memory media. The memory media stores various programs which the computer executes. The memory media is a semiconductor memory or a magnetic disc.

The CPU7 executes the programs stored in the memory 8 to perform a control of the fuel injector 3. The CPU 7 has a plurality of control portions.

The CPU 7 has a small-injection portion 7a for obtaining a small fuel injection quantity. The small injection quantity is obtained by stopping a supply of the valve-opening voltage before the fuel injector 3 reaches the full-open position from the full-close position.

The small-injection portion 7a has a first valve-open control portion 7b. The first valve-open control portion 7b supplies the valve-opening voltage to the coil 3c for opening the fuel injector 3. Furthermore, the first valve-open control portion 7b stops a supply of a valve-opening voltage after a predetermined period has elapsed. The first valve-open control portion 7b may stop supplying the electric supply to the coil 3c before the fuel injector 3 is positioned at a full-open position. The first valve-open control portion 7b controls the drive circuit 6 in such a manner that the high voltage supply 6a intermittently supply the electricity to the coil 3c. The valve-opening voltage is supplied to the coil 3c and magnetizing current flows. The first valve-open control portion 7b moves the needle 3b in a valve-opening direction and in a valve-closing direction.

The small-injection portion 7a includes a demagnetization portion 7c. The demagnetization portion 7c performs a demagnetization control. The demagnetization portion 7c performs the demagnetization control in order to quickly attenuate the residual magnetization energy remaining in the coil 3c.

In the demagnetization control, a demagnetization circuit is provided for attenuating the residual magnetism energy quickly. The demagnetization circuit can include a power source which supplies a reverse voltage contrary to a valve-opening voltage to the terminals 5a, 5b. The demagnetization circuit can be established by a closed circuit including the coil 3c. The demagnetization circuit is a dosed circuit through which electricity generated by the counter-electromotive force supplied to the terminals 5a, 5b from the coil 3c flows. The demagnetization portion 7c controls the drive circuit 6 to form the dosed circuit including the coil 3c. In a closed circuit, a circuit element for promoting attenuation of residual magnetism energy can be included. For example, a switching device, a resistor, etc.

In the demagnetization control, a reverse voltage relative to the valve-opening voltage can be supplied to the coil 3c. The reverse voltage promotes attenuation of residual magnetism energy. In this case, the demagnetization portion 7c controls the drive circuit 6 to supply the reverse voltage to the coil 3c.

The demagnetization portion 7c continues the demagnetization control from when the demagnetization control is started until when the fuel injector 3 is fully closed. The demagnetization control is terminated after the fuel injector 3 is fully dosed. The demagnetization control may be terminated immediately before the fuel injector 3 is fully closed.

The small-injection portion 7a has a first valve-close control portion 7d. The first valve-dose control portion 7d forms a dosed circuit after the demagnetization portion 7c generates the demagnetization circuit. The closed circuit makes the terminals 5a and 5b into an open condition (OPEN). Alternatively, the closed circuit makes the terminals 5a and 5b into a short circuit condition to the earth potential (GND).

The CPU 7 has a normal-injection portion 7e for injecting a fuel of a normal injection quantity. The normal injection quantity is obtained by stopping a supply of the valve-opening voltage after the fuel injector 3 reaches the full-open position from the full-dose position.

The normal-injection portion 7e includes a second valve-open control portion 7f. The second valve-open control portion 7f supplies the valve-opening voltage to the coil 3c for opening the fuel injector 3. Furthermore, the second valve-open control portion 7f stops a supply of a valve-opening voltage after a predetermined period has elapsed. The second valve-open control portion 7f stops supplying the electric supply to the coil 3c after the fuel injector 3 is positioned at a full-open position. The second valve-open control portion 7f controls the drive circuit 6 in such a manner that the high voltage supply 6a or the low voltage supply 6b intermittently supplies the electricity to the coil 3c. The valve-opening voltage is supplied to the coil 3c and magnetizing current flows. The second valve-open control portion 7f can move the needle 3b in a valve-opening direction or in a valve-opening direction.

Furthermore, the second valve-open control portion 7f has a valve-maintaining portion 7g. The valve-maintaining portion 7g keeps the electric current supplied to the terminals 5a, 5b at a target current, whereby the fuel injector 3 is kept full-open. The valve-maintaining portion 7g controls the drive circuit 6 in such a manner that the low voltage supply 6a supplies the electricity to the coil 3c. The valve-maintaining portion 7g controls the drive circuit 6 so that the electric current flowing through the coil 3c becomes a target current. Thereby, the power consumption in the valve-opening period is restricted. Moreover, since the power consumption is restricted, the fuel injector 3 promptly moves from the full-open position to the full-close position.

The normal-injection portion 7e includes a second valve-close control portion 7h. The second valve-close control portion 7h forms the stop circuit between the terminal 5a, 5b for maintaining the fuel injector 3 at full-close position. The normal-injection portion 7e does not include the control function equivalent to the demagnetization portion 7c. Therefore, the demagnetization control is not performed in a normal fuel injection. After the valve-maintaining portion 7 controls the electricity, the demagnetization portion 7c does not form the demagnetization circuit. The second valve-close control portion 7h doses the fuel injector 3 without generating the demagnetization circuit by the demagnetization portion 7c.

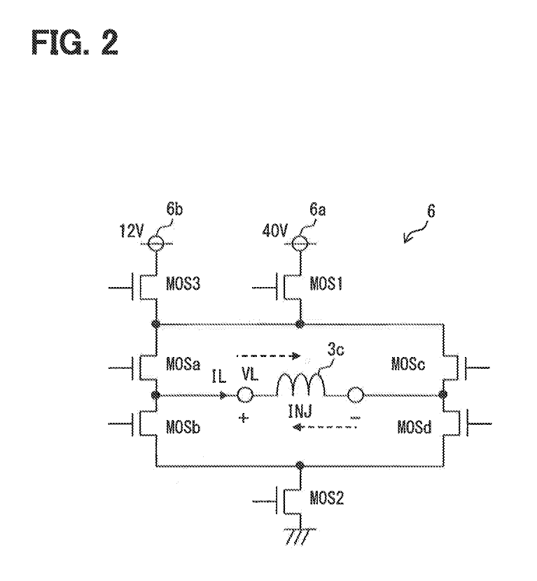

As shown in FIG. 2, the drive circuit 6 has H-bridge circuit including the coil 3c. The H-bridge circuit has MOSa, MOSb, MOSc and MOSd. The H-bridge circuit selectively turns ON the MOSa, MOSd or MOSb, MOSc, whereby the applied voltage to the coil 3c can be reversible in its direction.

A MOS1 is provided between the high voltage supply 6a and the H-bridge circuit. A MOS2 is provided between the H-bridge circuit and the earth potential A MOS3 is provided between the low voltage supply 6b and the H-bridge circuit. Therefore, the electric power can be supplied to the coil 3c of H-bridge circuit from the high voltage supply 6a or the low voltage supply 6b.

Above MOSa, MOSb, MOSc, MOSd, MOS1, MOS2 and MOS3 are switching devices. These switching devices are power MOSFET (metal oxide semiconductor field effect transistor). The switching device may be a bipolar transistor, or an IGBT (insulated gate type bipolar transistor).

The drive circuit 6 can selectively supply the valve-opening voltage (VF1, VF2), the stopping voltage (GND, OPEN) or the reverse voltage (VR) to the terminals 5a, 5b. The reverse voltage VR is a reverse of the voltage VF1 supplied from the high voltage supply 6a to the terminals 5a, 5b. (VR=−VF1) The drive circuit 6 can selectively supply the valve-opening voltage (VF1, VF2) or the stopping voltage (GND, VR) to the terminals 5a, 5b.

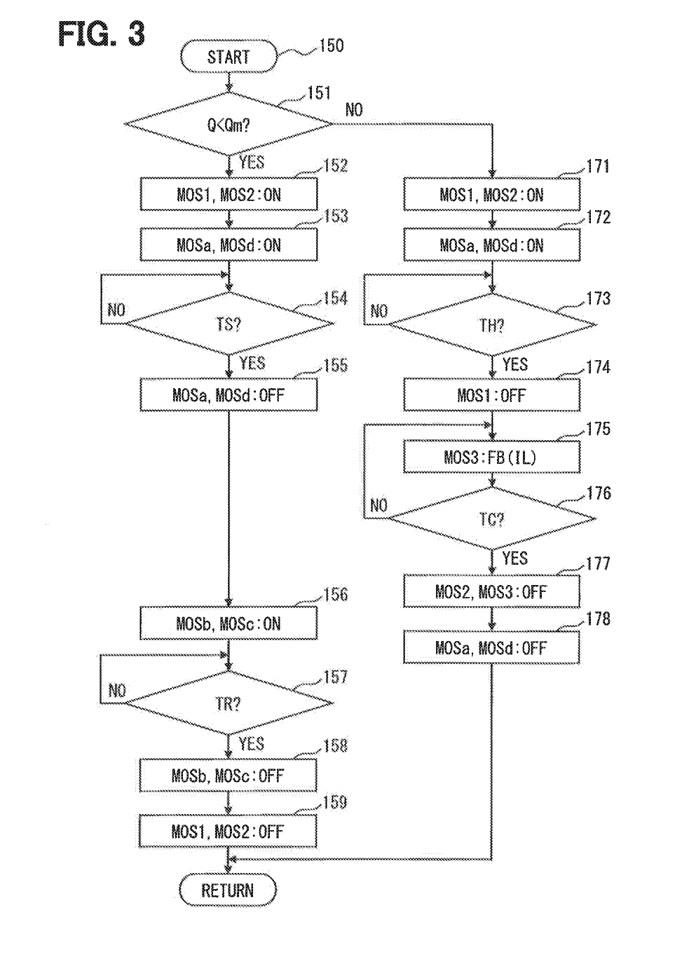

FIG. 3 is a flowchart showing a processing for controlling the drive circuit 6. This processing is started when a fuel injection command is generated. In step 151, the ECU 5 determines whether a fuel injection quantity “Q” is less than a threshold “Qm”. Based on the threshold “Qm”, the ECU 5 determines whether the current injection quantity is the small injection quantity or the usual injection quantity. When the answer is YES in step 151, the procedure proceeds to step 152. The processes in steps 152-159 correspond to the small-injection portion 7a. When the answer is NO in step 151, the procedure proceeds to step 171. The processes in steps 171-178 correspond to the normal-injection portion 7e.

In step 152, the ECU 5 turns ON the MOS1 and the MOS2. In step 153, the ECU 5 turns ON the MOSa and the MOSd. Thereby, the valve-opening voltage “VF1” is supplied to the coil 3c from the high voltage supply 6a. The electric current flows through the coil 3c, and the coil 3c is magnetized. The needle 3b is attracted towards the stator 3a. The fuel injector 3 starts a valve opening action. The needle 3b is gradually lifted up.

In step 154, the ECU 5 determines whether an electric supply period “TS” has elapsed. The electric supply period “TS” is established based on the fuel injection quantity “Q”. During the electric supply period “TS”, an electric power is supplied from the high voltage supply 6a to the coil 3c in order to obtain the small fuel injection quantity “Q”. Until the electric supply period “TS” has elapsed, the ECU 5 continues the electric supply to the coil 3c. When the electric supply period “TS” has elapsed, the procedure proceeds to step 155. As a result, the needle 3b is gradually lifted up until the electric supply period “TS” has elapsed. The fuel injector 3 is gradually opened and the fuel injection quantity is gradually increased.

In step 155, the ECU 5 turns OFF the MOSa and the MOSd. Thereby, the supply of valve-opening voltage is terminated. The magnetization of the coil 3c is also terminated. The needle 3b stops the movement in the valve-open direction and then starts to be apart from the stator 3a. That is, the fuel injector 3 starts a valve dosing operation before being fully opened. The lift amount of the needle 3b decreases gradually.

In step 156, the ECU 5 turns ON the MOSb and the MOSc. A circuit which supplies the reverse voltage (VR) to the coil 3c from the high voltage supply 6a to a valve-opening voltage is formed. As a result, the demagnetization control is performed. In this case, the voltage supplied to the terminals 5a, 5b is the reverse voltage (VR). This reverse voltage level is also the voltage for closing the fuel injector 3. This reverse voltage corresponds to the stopping voltage. This valve-closing voltage is also the voltage which demagnetizes the magnetism remaining in the coil 3c. The demagnetization portion 7 controls the drive circuit 6 to supply the valve-closing voltage (VR) instead of the valve-opening voltage (VF1). The demagnetization portion 7c controls the drive circuit 6 to supply the reverse voltage (VR) to the coil 3c instead of the valve-opening voltage (VF1).

The residual magnetism energy is disappeared by the reverse voltage. The magnetic force which the coil 3c generates decreases quickly. As a result, the needle 3b moves away from the stator 3a. The lift amount of the needle 3b decreases rapidly. The fuel injector 3 is quickly closed.

In step 157, the ECU 5 determines whether a valve-closing period “TR” has elapsed. The valve-dosing period “TR” is a time period which is necessary for the fuel injector 3 to be closed. The valve-closing period “TR” corresponds to a time delay from when the coil 3c is deenergized until when the fuel injector 3 is closed. The valve-closing period “TR” can be a predetermined fixed value or a variable value according to the fuel injection quantity “Q”.

When the valve-closing period “TR” has elapsed, the procedure proceeds to step 158. As a result, until the valve-dosing period “TR” has elapsed, the reverse voltage is supplied to the coil 3c. The lift amount of the needle 3b decreases quickly. The fuel injector 3 is rapidly closed and the fuel injection quantity is rapidly decreased.

In step 158, the ECU 5 turns OFF the MOSb and the MOSc. In step 159, the ECU 5 turns OFF the MOS1 and the MOS2. Thereby, the supply of reverse voltage is terminated. A stop circuit is formed between the terminals 5a, 5b. In this case, the voltage supplied to the terminals 5a, 5b is an open voltage level (OPEN). This voltage level is also the voltage for closing the fuel injector 3. No electric current flows through the coil 3c thoroughly.

The processes in steps 157-159 corresponds to the first valve-close control portion 7d. The first valve-dose control portion 7d forms a stop circuit for maintaining the fuel injector 3 at the full-close position. The first valve-close control portion 7d supplies the valve-closing voltage (OPEN) after the fuel injector 3 is fully dosed.

In step 171, the ECU 5 turns ON the MOS1 and the MOS2. In step 172, the ECU 5 turns ON the MOSa and the MOSd. Thereby, the valve-opening voltage “VF1” is supplied to the coil 3c from the high voltage supply 6a. The electric current flows through the coil 3c, and the coil 3c is magnetized. The needle 3b is attracted towards the stator 3a. The fuel injector 3 starts a valve opening action. The needle 3b is gradually lifted up.

In step 173, the ECU 5 determines whether a high-voltage period “TH” has elapsed. The high-voltage period “TH” is an energization period in which high voltage is supplied to the coil 3c from the high voltage supply 6a in order to open the fuel injector 3 at high speed. The high-voltage period “TH” is a time period which is necessary for the fuel injector 3 to move from the full-close position to the full-open position.

When the high-voltage period “TH” has elapsed, the procedure proceeds to step 174. As a result, the needle 3b is gradually lifted up until the high-voltage period “TH” has elapsed. The fuel injector 3 is gradually opened and the fuel injection quantity is gradually increased.

In step 174, the ECU 5 turns OFF the MOS1. Thereby, the supply of valve-opening voltage from the high voltage supply 6a is terminated. The magnetization of the coil 3c is also terminated. The MOS2 is maintained ON.

In step 175, the ECU 5 starts a switching control of the MOS3. The ECU 5 controls the MOS3 so that the electric current “IL” flowing through the coil 3c becomes a target current. Thereby, the valve-opening voltage “VF2” is supplied to the coil 3c from the low voltage supply 6b. The target current is established in such a manner as to maintain the fuel injector 3 at the full-open position. The target current is smaller than the maximum current which the low voltage supply 6b can supply to the coil 3c. The target current is established in such a manner as to maintain the fuel injector 3 at the full-open position. As a result, the coil 3c is magnetized state at the minimum level.

In step 176, the ECU 5 determines whether a valve-holding period “TC” has elapsed. The valve-holding period “TC” is a time period in which the fuel injector 3 is kept open. The valve-holding period “TC” can be established according to the fuel injection quantity “Q”. When the valve-holding period “TC” has elapsed, the procedure proceeds to step 177. As a result, until the valve-holding period “TC” has elapsed, the valve-opening voltage is supplied to the coil 3c.

In step 177, the ECU 5 turns OFF the MOS2 and the MOS3. Thereby, the supply of valve-opening voltage is terminated. The magnetization of the coil 3c is also terminated. The needle 3b moves away from the stator 3a. The fuel injector 3 starts a valve dosing action. The lift amount of the needle 3b decreases gradually.

In step 178, the ECU 5 turns OFF the MOSa and the MOSd. Both end terminals of the coil 3c are opened (OPEN).

In the normal injection (steps 171-178), no demagnetization control is performed. The residual magnetism energy is a little. The residual magnetism energy is lost at an early stage. As a result, the needle 3b moves away from the stator 3a. The lift amount of the needle 3b decreases rapidly. The fuel injector 3 is quickly closed.

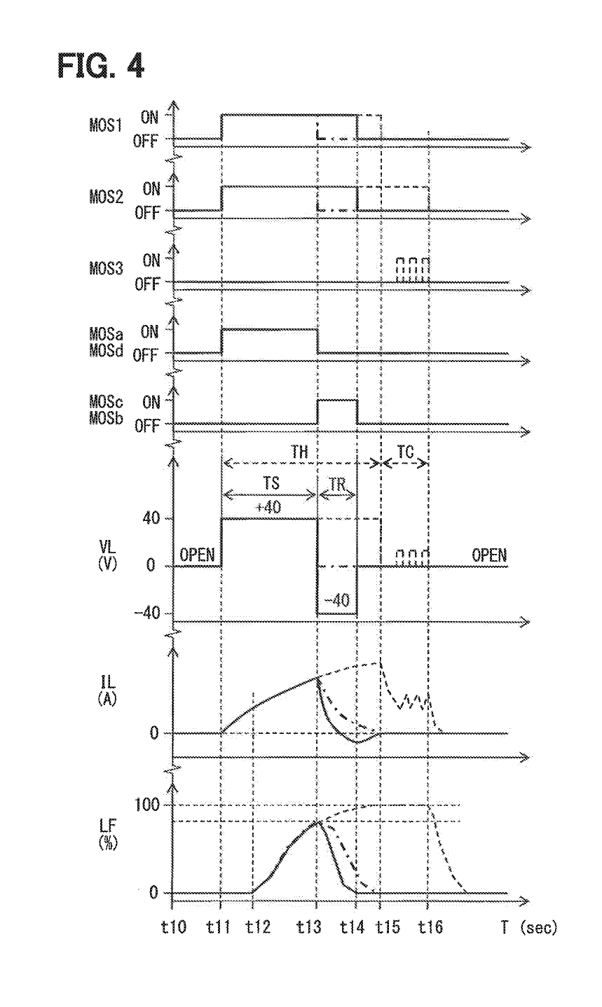

FIG. 4 is a time chart showing an operation of the present embodiment. “VL” denotes the voltage at a plus terminal of the coil 3c, “IL” denotes the electric current flowing through the coil 3c, and “LF” denotes the lift amount of the needle 3b.

In FIG. 4, solid lines show operations of the small injection quantity. At the time “t11”, the voltage is supplied to the coil 3c. In electric supply period “TS” from “t11” to “t13”, the voltage “VL” is “VF1”. The electric current “IL” is gradually increased. At the time “t12”, the lift amount “LF” of the needle 3b starts increasing.

In a case of small injection quantity, the electric supply period “TS” elapses before the fuel injector 3 is positioned at the full-open position. In FIG. 4, the electric supply period “TS” expires at the time “t13”. At the time “t13”, the direction of the electric current is reversed by the H-bridge circuit. The voltage “VL” is also reversed to the voltage “VR”. Thereby, the voltage for demagnetization is supplied to the coil 3c. The electric current IL decreases quickly and becomes lower than zero before the time “T14”. The residual magnetism energy of the coil 3c is decreased quickly. Therefore, the lift amount LF decreases quickly.

The lift amount “LF” returns to 0% at the time “t14”. That is, at the time “t14”, the fuel injector 3 is fully closed. At the time “t14”, all of the MOS1-MOS3 and MOSa-MOSd are turned OFF. After the fuel injector 3 is fully closed, the voltage applied to the coil 3c is changed to a full-close voltage. The full-close voltage corresponds to situation in which both ends of the coil 3c are opened (OPEN).

In FIG. 4, dashed lines show operations of the normal injection quantity. In the usual fuel injection, the voltage is supplied to the fuel injector 3 from the high voltage supply 6a. The lift amount LF reaches 100% at the time “t15”. The high-voltage period TH is a period between the time “t11” and the time “t15”. At the time “t15”, the MOS1 is turned OFF. The switching control of the MOS3 is started at the time “t15”. As a result, the voltage is intermittently supplied to the coil 3c from the low voltage supply 6b. The Electric current IL is controlled to become the target current. The lift amount “LF” Is maintained at a full open condition. When the valve-holding period “TC” has passed at “t16”, the MOS2 is turned OFF. The switching control of the MOS3 is terminated. The electric current “IL” is gradually decreased and the lift amount “LF” is also decreased.

In FIG. 4, chain lines shows operations of a case where demagnetization control is not performed in the small injection quantity. In this case, at the time “t13”, the MOS1 and the MOS2 are turned OFF. That is, before the fuel injector 3 is fully opened, the voltage supply to the coil 3c is terminated. The residual magnetism energy of the coil 3c is gradually decreased. The lift amount LF also decreases gradually. The fuel injector 3 is fully closed at the time “t15”. During a period from the time “t13” to the time “t5”, the fuel injection is continued. This period varies due to a mechanical dimension error of the fuel injector 3 and the environmental temperature. For this reason, when the demagnetization control is not performed, the small injection quantity includes some errors.

As described above, the supply of the valve-opening voltage is terminated before the fuel injector 3 is fully opened. Thereby, the fuel injection of small quantity can be obtained.

Further, when the supply of the valve-opening voltage is terminated, a circuit for attenuating the magnetic force of the coil 3c is formed. For this reason, the magnetic force of the coil 3c attenuates quickly. The fuel injector 3 moves in a valve closing direction quickly to be fully closed. As a result, the error of fuel injection quantity is restricted. The small fuel injection quantity can be controlled with high accuracy.

And according to the present embodiment, before the fuel injector 3 is fully dosed and after the supply of a valve-opening voltage is terminated, the reverse voltage is supplied to the coil 3c. For this reason, the electric current flowing through the coil 3c is decreased quickly, and the magnetic force of the coil 3c quickly decreases. As a result, the error of fuel injection quantity is restricted.

Furthermore, according to this embodiment, after the fuel injector 3 is fully closed, the reverse voltage is stopped and the voltage supplied to the coil 3c is set to zero volt. The demagnetization of the coil 3c is promoted.

### Second Embodiment

In the above embodiment, the reverse voltage for demagnetization is supplied to the coil 3c. However, only the closed circuit for demagnetization may be formed without supplying the reverse voltage. For example, a closed circuit CC1 having a resistor “R” for attenuating the electric current resulting from the residual magnetism energy of the coil 3c can be formed.

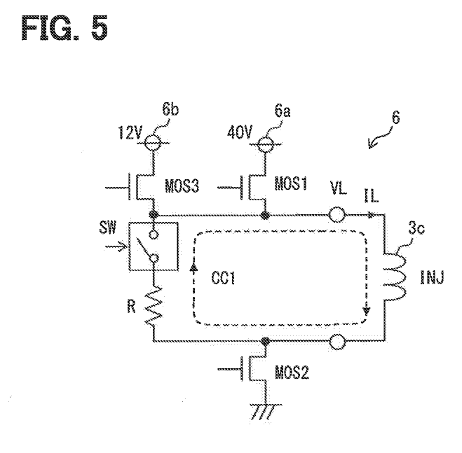

In FIG. 5, the drive circuit 6 of the second embodiment does not have H-bridge circuit. The drive circuit 6 is provided with a switching device “SW” and a resistor “R” between the terminals 5a, 5b. The switching device “SW” is a semiconductor switching device, such as a MOSFET. Alternatively, the switching device “SW” may be a diode. The diode “Df” closes the dosed circuit CC1 including the coil 3c and the resistor “R” by counter-electromotive force induced by the coil 3c. The diode “Df” stops supplying electric power through the resistor “R”, when the high voltage supply 6a or the low voltage supply 6b supplies electric power to the coil 3c.

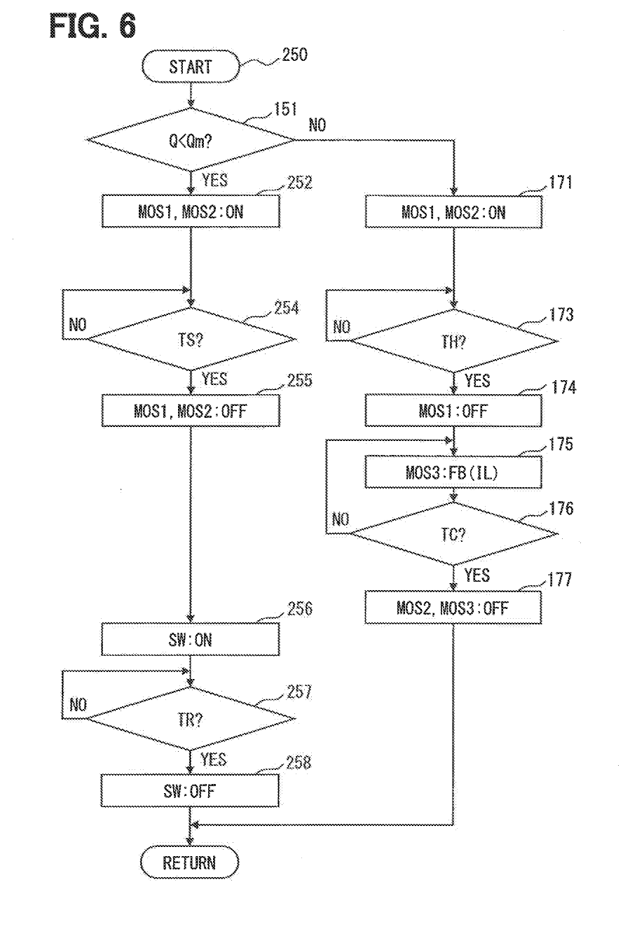

FIG. 6 is a flowchart showing a processing for controlling the drive circuit 6. The same processes as those in the above embodiments are indicated with the same reference numerals.

In step 252, the ECU 5 turns ON the MOS1 and the MOS2. Thereby, the valve-opening voltage “VF1” is supplied to the coil 3c from the high voltage supply 6a.

In step 254, the ECU 5 determines whether the electric supply period “TS” has elapsed. When the electric supply period “TS” passes, the ECU 5 turns OFF the MOS1 and the MOS2 in step 255. Thereby, the supply of valve-opening voltage is terminated.

In step 256, the ECU 5 turns ON the switching device “SW”. As a result, the closed circuit “CC1” including the coil 3c and the resistor R is formed. As a result, the demagnetization control is performed.

In this case, the voltage supplied to the terminals 5a, 5b is a short circuit voltage level (GND). This voltage level is also the voltage for closing the fuel injector 3. This voltage level is the valve-closing voltage. This valve-closing voltage is also the voltage which demagnetizes the magnetism remaining in the coil 3c. The demagnetization portion 7c controls the drive circuit 6 to supply the valve-closing voltage (GND) instead of the valve-opening voltage (VF1).

The closed circuit CC1 has low impedance relative to the counter-electromotive force induced by the coil 3c. An electricity flows through the closed circuit CC1.

In step 257, the ECU 5 determines whether the valve-closing period “TR” has elapsed. When the valve-dosing period “TR” has elapsed, the procedure proceeds to step 258. As a result, until the valve-closing period “TR” has elapsed, the dosed circuit CC1 is closed. Since the closed circuit CC1 has the resistor “R”, the residual magnetism energy of the coil 3c is attenuated quickly.

In step 258, the ECU 5 turns OFF the switching device “SW”. No electric current flows through the coil 3c thoroughly. The processes in steps 257-258 corresponds to the first valve-dose control portion 7d.

The processes in steps 252, 254 to 258 correspond to the small-injection portion 7a. The processes in steps 171, 173 to 177 correspond to the normal-injection portion 7e.

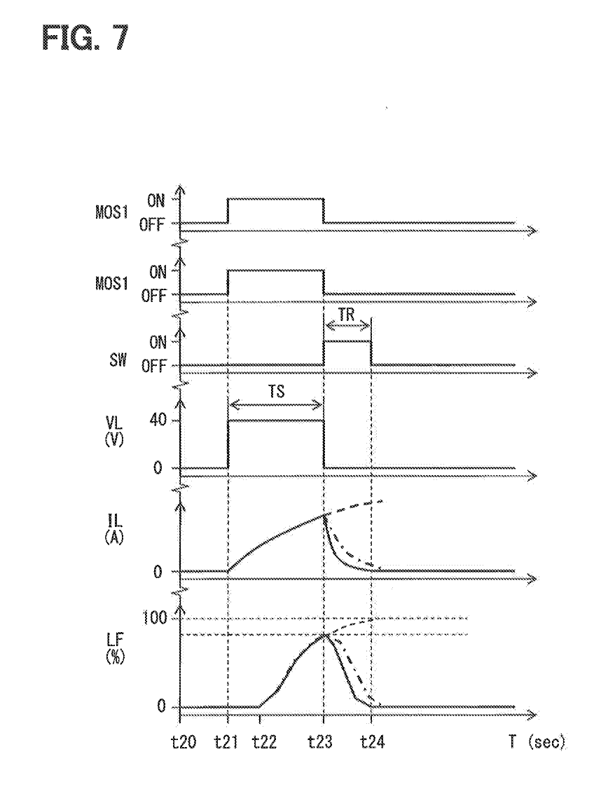

FIG. 7 is a time chart showing an operation of the present embodiment. In FIG. 7, solid lines show operations of the small injection quantity. At the time “t21”, the voltage is supplied to the coil 3c. In electric supply period “TS” from “t21” to “t23”, the voltage “VL” is supplied. The voltage “VL” is +40V. The electric current “IL” is gradually increased. At the time “122”, the lift amount “LF” of the needle 3b starts increasing.

In a case of small injection quantity, the electric supply period “TS” elapses before the fuel injector 3 is positioned at the full-open position. In FIG. 7, the electric supply period “TS” expires at the time “t23”. At the time “t23”, the switching device “SW” is turned OFF. As a result, the closed circuit “CC1” including the coil 3c is dosed. The electric current “IL” decreases quickly. The residual magnetism energy of the coil 3c is decreased quickly. Therefore, the lift amount LF decreases quickly.

The lift amount “LF” returns to 0% at the time “t24”. That is, at the time “t24”, the fuel injector 3 is fully dosed. At the time “t24”, all of the MOS1 to MOS3 are turned OFF, and the switching device SW is turned OFF. After the fuel injector 3 is fully dosed, the voltage applied to the coil 3c is changed to a normal level.

According to this embodiment, demagnetization control is performed only by dosing closed circuit CC1.

### Third Embodiment

According to the third embodiment, a dosed circuit CC2 which short-circuits between the terminal 5a and 5b is formed.

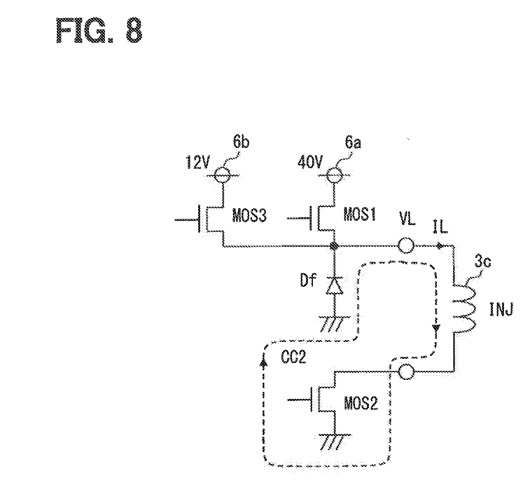

In FIG. 8, the drive circuit 6 of the third embodiment does not have H-bridge circuit.

The drive circuit 6 is provided with a diode “Df” between the plus terminal of coil 3c and the earth potential. An anode of the diode “Df” is connected to the earth potential and a cathode is connected to the plus terminal of the coil 3c. The diode “Df” closes the closed circuit CC2 including the coil 3c by counter-electromotive force induced by the coil 3c. The diode “Df” stops supplying electric power through the closed circuit CC2, when the high voltage supply 6a or the low voltage supply 6b supplies electric power to the coil 3c.

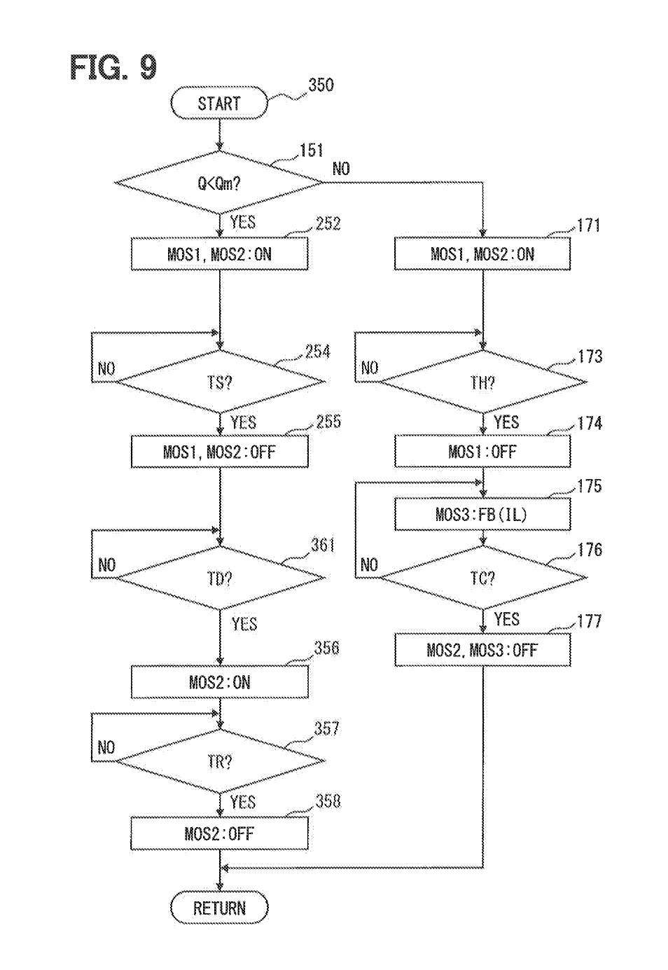

FIG. 9 is a flowchart showing a processing for controlling the drive circuit 6. The same processes as those in the above embodiments are indicated with the same reference numerals.

In step 361, the ECU 5 determines whether a delay period “TD” has elapsed. When the delay period “TD” has elapsed, the procedure proceeds to step 356. As a result, until the delay period “TD” has passed, both ends of the coil 3c are set to the open condition.

When a supply of the valve-opening voltage to the coil 3c is stopped in step 255, the counter-electromotive force is generated in the coil 3c by its self induction. The delay period “TD” is established in such a manner as to include a peak of the flyback voltage which appears between both terminals of the coil 3c by the counter-electromotive force. The delay period “TD” is established in such a manner as to expire when the flyback voltage decreases by a predetermined quantity. By opening the both end terminals of the coil 3c over the delay period “TD”, the attenuation of the residual magnetism energy of the coil 3c can be promoted.

In step 356, the ECU 5 turns ON the MOS2. As a result, the closed circuit CC2 including the coil 3c and the diode “Df” is formed. As a result, the demagnetization control is performed.

In this case, the voltage supplied to the terminals 5a, 5b is a short circuit voltage level (GND). This voltage level is also the voltage for closing the fuel injector 3. This voltage level is valve-closing voltage. This valve-closing voltage is also the voltage which demagnetizes the magnetism remaining in the coil 3c. The demagnetization portion 7c controls the drive circuit 6 to supply the valve-closing voltage (GND) instead of the valve-opening voltage (VF1).

The closed circuit CC2 has low impedance relative to the counter-electromotive force induced by the coil 3c. An electricity flows through the closed circuit CC2.

In step 357, the ECU 5 determines whether a valve-closing period “TR” has elapsed. When the valve-closing period “TR” has elapsed, the procedure proceeds to step 358. As a result, until the valve-dosing period “TR” has elapsed, the dosed circuit CC2 is closed.

In step 358, the ECU 5 turns OFF the MOS2. No electric current flows through the coil 3c thoroughly. The processes in steps 357-358 corresponds to the first valve-close control portion 7d.

The processes in steps 252, 254, 255, 361, 365 to 358 correspond to the small-injection portion 7a. The processes in steps 171, 173 to 177 correspond to the normal-injection portion 7e.

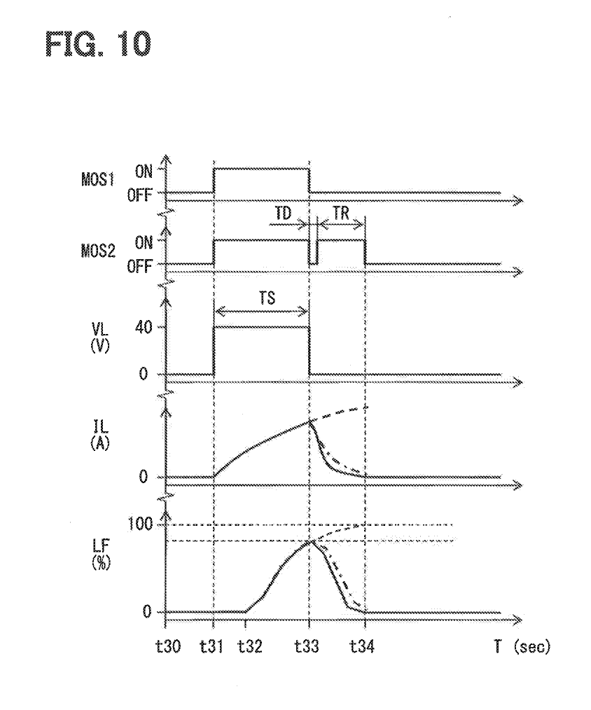

FIG. 10 is a time chart showing an operation of the present embodiment. In FIG. 10, solid lines show operations of the small injection quantity. At the time “t31”, the voltage is supplied to the coil 3c. In electric supply period “TS” from “t31” to “t33”, the voltage “VL” is “VF1”. The electric current “IL” is gradually increased. At the time “t32”, the lift amount “LF” of the needle 3b starts increasing.

In a case of small injection quantity, the electric supply period “TS” elapses before the fuel injector 3 is positioned at the full-open position. The electric supply period “TS” expires at the time “t33”. In this case, at the time “t33”, the MOS1 and the MOS2 are turned OFF. Thereby, both terminal ends of the coil 3c are opened. When the delay period TD has passed, the MOS2 is turned ON. As a result, the closed circuit “CC2” Including the coil 3c is closed. The electric current “IL” decreases quickly. The residual magnetism energy of the coil 3c is decreased quickly. Therefore, the lift amount LF decreases quickly.

The lift amount “LF” returns to 0% at the time “t34”. That is, at the time “t34”, the fuel injector 3 is fully closed. At the time “t34”, the MOS1 to the MOS3 are turned OFF. After the fuel injector 3 is fully dosed, the voltage applied to the coil 3c is changed to a normal level.

According to this embodiment, demagnetization control is performed only by closing closed circuit CC2.

### Other Embodiment

The preferred embodiments are described above. The present disclosure is not limited to the above embodiment.

For example, the control units can be configured by software, hardware or a combination thereof. For example, the ECU can be configured by an analog circuit.

When the fuel injector 3 is fully closed, the terminals 5a, 5b receive the full-close voltage. The full-close voltage corresponds to situation in which both ends of the coil 3c are opened (OPEN). Alternatively, both ends of the coil 3c may be switched to the short circuit condition (GND). The first valve-close control portion 7d controls the driving circuit 6 to supply the full-close voltage (GND) after the fuel injector 3 is fully closed.

The valve-opening voltage supplied from the high voltage supply 6a is +40V. The valve-opening voltage supplied from the low voltage supply 6b may be +12V.

In the third embodiment, step 361 may be deleted. In this case, the demagnetization portion 7c changes to the valve-opening voltage (VF1) to the valve-closing voltage (GND), without the delay period TD.

In the first embodiment and the second embodiment, the delay period TD may be set between the electric supply period TS and the valve-closing period TR.

Moreover, the voltage values of the high voltage supply 6a and the low voltage supply 6b can be changed.

What is claimed is:

1. A fuel injection controller which has terminals connectable to a coil of a fuel injector, comprising:
a valve-open control portion which supplies a valve-opening voltage to the terminals for opening the fuel injector and terminates the supply of the valve-opening voltage before the fuel injector is fully opened; and
a demagnetization portion which forms a demagnetization circuit for demagnetizing a magnetism remaining in the coil after supplying the valve-opening voltage.

2. A fuel injection controller according to claim 1, wherein
the demagnetization circuit includes a power source which supplies a reverse voltage contrary to the valve-opening voltage to the terminal.

3. A fuel injection controller according to claim 1, wherein
the demagnetization circuit is a dosed circuit through which an electricity flows through the terminals by a counter-electromotive force supplied to the terminal from the coil.

4. A fuel injection controller according to claim 1, further comprising:
a drive circuit selectively supplying the valve-opening voltage or a valve-closing voltage to the terminal; wherein
the valve-open control portion controls the drive circuit in such a manner as to terminate the supply of the valve-opening voltage before the fuel injector is fully opened, and
the demagnetization portion controls the drive circuit in such a manner as to supply a valve-closing voltage instead of the valve-opening voltage.

5. A fuel injection controller according to claim 4, wherein
the valve-closing voltage is a voltage which demagnetizes a magnetism remaining in the coil.

6. A fuel injection controller according to claim 1, further comprising:
a valve-dose control portion forming a stop circuit for maintaining the fuel injector at the full-dose position, after the demagnetization circuit is formed and the fuel injector is fully closed.

7. A fuel injection controller according to claim 1, further comprising:
a drive circuit selectively supplying the valve-opening voltage, the stopping voltage or the reverse voltage to the terminals, wherein
the valve-open control portion controls the drive circuit in such a manner as to terminate the supply of the valve-opening voltage before the fuel injector is fully opened;
the demagnetization portion controls the drive circuit to supply the reverse voltage; and
a valve-close control portion controls the drive circuit to supply the valve-closing voltage after the fuel injector is fully dosed.

8. A fuel injection controller according to claim 7, wherein
the reverse voltage is a voltage which demagnetizes a magnetism remaining in the coil.

9. A fuel injection controller according to claim 7, further comprising:
another valve-open control portion which supplies a valve-opening voltage to the terminals for opening the fuel injector and terminates the supply of the valve-opening voltage after the fuel injector is fully opened;
a valve-maintaining portion controls an electric current to a target value so that the fuel injector is kept full open; and
another valve-dose control portion which forms a stop circuit for closing the fuel injector without forming the demagnetization circuit.
